(19) United States
(12) Patent Application Publication
(10) Pub. No.: US 2026/0022248 A1
(43) Pub. Date: Jan. 22, 2026

(54) EMULSION BLEND FOR COATING CARBONATES

(71) Applicant: SPECIALTY MINERALS (MICHIGAN) INC., Plymouth, MI (US)

(72) Inventors: Brandon K. HUCALUK, New York, NY (US); Keith A. WELP, New York, NY (US)

(21) Appl. No.: 18/861,569

(22) PCT Filed: Oct. 6, 2023
(86) PCT No.: PCT/US2023/076209

§ 371 Date: Oct. 29, 2024

Related U.S. Application Data
(60) Provisional application No. 63/414,210, filed on Oct. 7, 2022.
(60) Provisional application No. 63/542,266, filed on Oct. 3, 2023.

(51) Int. Cl. C09C 1/02; C09C 3/00; C09C 3/04; C09C 3/08

(52) U.S. Cl. CPC C09C 1/021; C09C 3/006; C09C 3/043; C09C 3/08; C01P 2004/62; C01P 2004/64

(57) ABSTRACT

Provided herein are compositions and methods for the coating of nanoparticulates. More specifically, the present invention relates to a coated carbonate, a process for the preparation of such, and its use as an additive in the production of composite.

### CROSS-REFERENCES TO RELATED APPLICATIONS

This application claims the priority of U.S. Provisional Application Nos. 63/414,210 (filed Oct. 7, 2022) and 63/542,266 (filed Oct. 3, 2023), which are incorporated by reference in its entirety for all purposes.

### FIELD

Provided herein are compositions and methods of preparation including nanoparticulate carbonate salts with organic compositions including one or more fatty acids.

### BACKGROUND OF THE INVENTION

Carbonates may be used as a filler material for resin, but they are often surface treated to modify their polarity and chemical properties. Surface-treated carbonates can provide improved features, such as improved dispersability and adhesive properties. See, e.g., U.S. Pat. Nos. 6,686,044 and 4,191,670. These and other properties, however, can be further tailored for use in specific applications or composites.

Therefore, there is a continuing need for compositions and related methods including carbonate salts that are surface treated with an unsaturated fatty acid or a fatty acid mixture.

### SUMMARY OF THE INVENTION

Provided herein are compositions and methods including surface-treated carbonate salt (e.g., calcium carbonate) nanoparticles, in which the surface treatment includes an unstaturated fatty acid. such as eladic acid, or a fatty acid mixture, such as a tall oil fatty acid (TOFA).

In certain aspects and embodiments, the composition provided herein is a nanoparticulate composition, including surface-treated carbonate salt (e.g., calcium carbonate) nanoparticles:
wherein the carbonate salt nanoparticles are treated with a fatty acid mixture including from about 40% to about 80% of a saturated fatty acid or mixture thereof and from about 20% to about 60% of an unsaturated fatty acid or mixture thereof:
wherein the unsaturated fatty acid or mixture thereof includes at least about 10% elaidic acid or a salt thereof.

In certain embodiments, the unsaturated fatty acid or mixture thereof includes at least about 20% elaidic acid or a salt thereof.

In certain embodiments, provided herein is a filler composition comprising the nanoparticle composition as disclosed herein.

In certain embodiments, provided herein is a method of preparing the nanoparticle composition as otherwise disclosed in an embodiment herein, the method comprising:
preparing a surface coating emulsion comprising the fatty acid mixture under basic conditions; and
mixing the calcium carbonate nanoparticles with the surface coating emulsion.

These and other objects, aspects, and embodiments will become more apparent when read with the following detailed description.

### DETAILED DESCRIPTION

### Description of Exemplary Embodiments

Provided herein are compositions and methods including surface-treated calcium carbonate nanoparticles, in which the surface treatment includes an unsaturated fatty acid, such as eladic acid, or a fatty acid mixture, such as a tall oil fatty acid (TOFA).

### Definitions

When referring to the compounds provided herein, the following terms have the following meanings unless indicated otherwise. Unless defined otherwise, all technical and scientific terms used herein have the same meaning as is commonly understood by one of ordinary skill in the art. If there is a plurality of definitions for a term herein, those in this section prevail unless stated otherwise.

The terms “a” and “an” as used herein, unless otherwise specified, not only include aspects and embodiments with one member, but also include aspects and embodiments with more than one member. For example, a composition comprising a saturated fatty acid and an unsaturated fatty acid should be understood to present aspects with at least a second saturated fatty acid, at least a second unsaturated fatty acid, or both.

The term “about.” as used herein to modify a numerical value, unless otherwise specified, refers to a defined range around that value. For example, “about X” would generally indicate a value from 0.95X to 1.05X. Any reference to “about X” specifically would indicate at least the values 0.95X, 0.96X, 0.97X, 0.98X, 0.99X, 1.00X, 1.01X, 1.02X, 1.03X, 1.04X, and 1.05X. Thus, “about X” is intended to teach and to provide written description support for a claim limitation of, e.g., “0.98X” as well as for “X.”

When “about” is applied to the beginning of a numerical range, it applies to both ends of the range. Thus, “from about 50 nm to 300 nm” is equivalent to “from about 50 nm to about 300 nm.” When “about” is applied to the beginning of a list of values, it applies to the members of the list. Thus, “about 50, 60, or 75%” is equivalent to “about 50%, about 60%, or about 75%.”

The terms “nanoparticle” and “nanoparticulate” as used herein, unless otherwise specified, refers to one or more objects with dimensions on the nanoscale (i.e., within the range of about I to 500 nanometers in length, width. and height).

As used herein, the term “or” should in general be construed as a Boolean “or” (i.e., not excluding “and”). For example, an embodiment of “a composition comprising A or B” would typically present an aspect with a composition comprising both A and B. The term “or” should be construed to exclude those aspects presented that cannot be combined without contradiction.

The term “%” or “percent composition,” as used herein, unless otherwise specified, refers to a weight/weight percentage (i.e., w/w). For example, a composition that includes 67% fatty acids would include 67 g of fatty acids in each 100 g of the total composition. while a composition with 40% saturated and 60% unsaturated fatty acids would include 40 g of unsaturated fatty acids for each 60 g of saturated fatty acids. An unsaturated fatty acid or mixture thereof comprising at least 10% elaidic acid would include at least 10 g elaidic acid in each 100 g of the unsaturated fatty acid or acids.

The term “saturated fatty acid” as used herein, unless otherwise specified, refers to a fatty acid R^{a}—CO₂H or a salt thereof, in which R^{a} is an aliphatic hydrocarbon chain that may be straight-chain (i.e., unbranched) or branched, and in which R^{a} includes no carbon-carbon double or triple bond. The saturated acid or R^{a} hydrocarbon chain may contain a specified number or range of carbon atoms. For example, palmitic acid is a C₁₆ saturated fatty acid, while “C₆-C₃₀ saturated fatty acid” indicates that the fatty acid may have from six to 30 carbon atoms.

The term “unsaturated fatty acid” as used herein, unless otherwise specified, refers to a fatty acid R^{b}—CO²H or a salt thereof, in which R^{b} is an aliphatic hydrocarbon chain that may be straight-chain (i.e., unbranched) or branched, and in which R^{b} includes at least one carbon-carbon double or triple bond. The unsaturated acid or R^{b} hydrocarbon chain may contain a specified number or range of carbon atoms. For example, elaidic acid is a C₁₈ unsaturated fatty acid with a single trans-alkene, while “C₁₂-C₃₀ unsaturated fatty acid” indicates that the fatty acid may have from twelve to 30 carbon atoms.

### Compositions

In certain embodiments, provided herein is a nanoparticulate composition, including surface-treated calcium carbonate nanoparticles.

In certain embodiments, provided herein is a nanoparticulate composition, including surface-treated calcium carbonate nanoparticles:
wherein the calcium carbonate nanoparticles are treated with a fatty acid mixture including from about 40% to about 80% of a saturated fatty acid or mixture thereof and from about 20% to about 60% of an unsaturated fatty acid or mixture thereof;
wherein the unsaturated fatty acid or mixture thereof includes at least about 10% elaidic acid or a salt thereof.

In certain embodiments, the unsaturated fatty acid or mixture thereof includes at least about 20% elaidic acid or a salt thereof.

In certain embodiments, the unsaturated fatty acid or mixture thereof includes at least about 5% elaidic acid or a salt thereof.

In certain embodiments, the unsaturated fatty acid is elaidic acid or a salt thereof. In certain embodiments, the unsaturated fatty acid comprises elaidic acid or a salt thereof.

In certain embodiments, provided herein are the nanoparticulate composition as disclosed herein, wherein the unsaturated fatty acid or mixture thereof is a tall oil fatty acid (TOFA) (e.g., Altapyne® 1483 or the like) or a salt thereof. In certain embodiments, provided herein are the nanoparticulate composition as disclosed herein, wherein the unsaturated fatty acid or mixture thereof comprises a TOFA or a salt thereof.

In certain embodiments, the unsaturated fatty acid or mixture thereof is a vegetable-oil-derived mixture (e.g., AltaVeg™ FA 140 or the like) or a salt thereof. In certain embodiments, provided herein are the nanoparticulate composition as disclosed herein. wherein the unsaturated fatty acid or the mixture thereof comprises a vegetable-oil-derived mixture or a salt thereof.

In certain embodiments, the unsaturated fatty acid or mixture thereof comprises a TOFA and a vegetable-oil-derived mixture (e.g., AltaVeg™ FA 140 or the like) or a salt thereof. In certain embodiments, the unsaturated fatty acid or the mixture thereof is a mixture of a TOFA and a vegetable-oil-derived mixture or a salt thereof.

In certain embodiments, the tall oil fatty acid (TOFA) includes about 5% to 13% saturated fatty acids (e.g., about 5, 6, 7, 8, 9, 10, 11, 12, or 13%, such as 10%) and about 75% to about 95% (e.g., about 75, 76, 77, 78, 79, 80, 81, 82, 83, 84, 85, 86, 87, 88, 89, 90, 91, 92, or 93%, such as 83%) unsaturated fatty acids.

In certain embodiments, provided herein are the nanoparticulate composition as disclosed herein, wherein the average particle diameter is from about 30 nm (e.g., about 25, 30, 35, 45, 50, 55, 60, 65, 70, 75, 80, 85, 90, 95, or 100) to about 200 nm (e.g., about 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, or 275 nm). In certain embodiments. the average particle diameter is from about 50 nm to about 150 nm.

In certain embodiments, provided herein are the nanoparticulate composition as disclosed herein, wherein the fatty acid mixture is from about 40% (e.g., about 30, 31, 32, 33, 34, 35, 36, 37, 38, 39, 40, 41, 42, 43, 44, 45, 46, 47, 48, 49, or 50%) to about 64% (e.g., about 50, 51, 52, 53, 54, 55, 56, 57, 58, 59, 60, 61, 62, 63, 64, 65, 66, 67, 68, 69, 70, 71, 72, 73, 74, or 75%) of a saturated fatty acid or mixture thereof and from about 36% (e.g., about 25, 26, 27, 28, 29, 30, 31, 32, 33, 34, 35, 36, 37, 38, 39, 40, 41, 42, 43, 44, or 45%) to about 60% (e.g., about 50. 51, 52, 53, 54, 55, 56, 57, 58, 59, 60, 61, 62, 63, 64, 65, 66, 67, 68, 69, or 70%) of an unsaturated fatty acid or mixture thereof.

In certain embodiments, provided herein are the nanoparticulate composition as disclosed herein, wherein the fatty acid mixture is from about 40% to about 80% (e.g., about 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, or 84%) of a saturated fatty acid or mixture thereof (e.g., stearic acid or a mixture of stearic and palmitic acid or a salt thereof) and from about 60% to about 20% (e.g., about 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, or 19%) of an unsaturated fatty acid or mixture thereof (e.g., a TOFA, such as Altapyne® 1483, or a salt thereof).

In certain embodiments, provided herein are the nanoparticulate composition as disclosed herein, wherein the fatty acid mixture is about 60% of the saturated fatty acid or mixture thereof and about 40% of the unsaturated fatty acid or mixture thereof.

In certain embodiments, the saturated fatty acid is selected from the group consisting of capric acid, lauric acid, myristic acid, palmitic acid, stearic acid, arachidic acid, behenic acid, lignoceric acid, cerotic acid, montanic acid, melissic acid, and a salt thereof.

In certain embodiments, provided herein are the nanoparticulate composition as disclosed herein, wherein the saturated fatty acid or mixture thereof comprises stearic acid or a salt thereof and palmitic acid or a salt thereof.

In certain embodiments, the unsaturated fatty acid is a C₁₆-C₂₂ unsaturated fatty acid or mixture of C₁₆-C₂₂ unsaturated fatty acids. In certain embodiments. the unsaturated fatty acid is selected from the group consisting of oleic acid, palmitoleic acid, elaidic acid, a-linolenic acid, linoleic acid (conjugated or non-conjugated), and a salt thereof.

In certain embodiments, provided herein are the nanoparticulate composition as disclosed herein, wherein the unsaturated fatty acid or mixture thereof comprises at least about 40% (e.g., at least about 20, 25, 30, 35, 36, 37, 38, 39, 40, 41, 42, 43, 44, 45, 46, 47, 48, 49, 50, 55, 60, or 65%) elaidic acid or a salt thereof.

In certain embodiments, provided herein are the nanoparticulate composition as disclosed herein, wherein the unsaturated fatty acid or mixture thereof comprises at least about 20% (e.g., at least about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 61, 62, 63, 64, or 65%) elaidic acid or a salt thereof.

In certain embodiments, provided herein are the nanoparticulate composition as disclosed herein, wherein the unsaturated fatty acid or mixture thereof comprises at least about 10% (e.g., at least about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 61, 62, 63, 64, or 65%) elaidic acid or a salt thereof.

In certain embodiments, provided herein are the nanoparticulate composition as disclosed herein, wherein the unsaturated fatty acid or mixture thereof comprises at least about 5% (e.g., at least about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 61, 62, 63, 64, or 65%) elaidic acid or a salt thereof.

In certain embodiments, the unsaturated fatty acid is a mixture of fatty acids comprising oleic acid, elaidic acid, linoleic acid (conjugated and non-conjugated), and a salt thereof. In certain embodiments. the unsaturated fatty acid is is a mixture of fatty acids comprising elaidic acid or a salt thereof.

In certain embodiments. provided herein are the nanoparticulate composition as disclosed herein, wherein the unsaturated fatty acid or mixture thereof comprises oleic acid or a salt thereof and linoleic acid or a salt thereof.

In certain embodiments, provided herein are the nanoparticulate composition as disclosed herein, wherein the unsaturated fatty acid or mixture thereof comprises less than about 30% (e.g., less than about 35, 30, 25, 20, 15, 10, 5, or 1%) linolenic acid or a salt thereof.

In certain embodiments, provided herein is a filler composition comprising the nanoparticle composition as disclosed herein.

In certain embodiments, provided herein is a method of preparing the nanoparticle composition as otherwise disclosed in an embodiment herein. the method comprising:
preparing a surface coating emulsion comprising the fatty acid mixture under basic conditions: and
mixing the calcium carbonate nanoparticles with the surface coating emulsion.

In certain embodiments, provided herein is a method of preparing the nanoparticle composition as otherwise disclosed in an embodiment herein. wherein preparing the surface coating emulsion comprises:
preparing a mixture with from about 5% to about 9% solids: and
stirring the mixture at about 80 to 85° C.

In certain embodiments, the mixture is about 4, 5, 6, 7, 8, 9, or 10% solids.

In certain embodiments, provided herein is a method of preparing the nanoparticle composition as otherwise disclosed in an embodiment herein, wherein stirring the mixture lasts for at least about 30 min (e.g., at least about 30, 35, 40, 45, 50, 55, or 60 min).

In certain embodiments, provided herein is a method of preparing the nanoparticle composition as otherwise disclosed in an embodiment herein. wherein the basic conditions require at least about 1.03 equivalents of strong base (e.g., about 1.03, 1.04, 1.05, 1.06, 1.07, 1.08, 1.09, 1.10, 1.15, 1.20, 1.25, 1.3, 1.4, or 1.5 equivalents).

In certain embodiments, provided herein is a method of preparing the nanoparticle composition as otherwise disclosed in an embodiment herein, wherein the method of preparing the nanoparticle composition further comprises:
dewatering the surface-treated calcium carbonate nanoparticles.

### Preparation of Components

The component compounds and nanoparticulate carbonate salt provided herein can be prepared, isolated, or obtained by any method apparent to those of skill in the art.

### EXAMPLES

As used herein. the symbols and conventions used in these processes. schemes, and examples. regardless of whether a particular abbreviation is specifically defined, are consistent with those used in the contemporary scientific literature.

### Example 1

### Tall Oil Fatty Acid (TOFA) Process Description

After producing ultrafine precipitated calcium carbonate (PCC) with a primary particle size ranging from 30 nm to 200 nm (more specifically, from 50 nm to 150 nm), the surface of the particle is surface treated with a hydrophobic agent.

The surface coating is prepared using a blend of 60% stearic acid (e.g., a mixture of ˜41-50% palmitic acid (C₁₆) and ˜42-52% stearic acid (C₁₈)) with 40% TOFA (e.g., Altapyne® 1483). The 60/40 blend is converted into a fatty acid salt by mixing enough NaOH or KOH to reach the stoichiometric point comprising 3-10% excess NaOH or KOH to ensure full conversion of the fatty acid into a salt. The emulsion is made in 80-85° C. water at 5-9% solids and allowed to mix for a minimum of 30 minutes to ensure proper micelle formation.

The resulting emulsion is then mixed with 80-85° C. ultrafine PCC slurry. The coated slurry is passed through a mixing pump to induce shear and is recirculated back into the holding tank before de-watering.

### Example 2

### Elaidic Acid Process Description

The procedure is conducted according to the procedure of Example 1, except instead of TOFA, the surface coating is prepared with 40% of elaidic acid.

### Example 3

### Elaidic Acid Composition Process Description

The procedure is conducted according to the procedure of Example 1, except instead of TOFA, the surface coating is prepared with 40% of an acid mixture comprising at least 30% elaidic acid.

### Example 4

### Vegetable-Oil-Derived Composition Process Description

The procedure is conducted according to the procedure of Example 1, except instead of TOFA, the surface coating is prepared with 40% of a vegetable-oil-derived acid mixture comprising about 11% elaidic acid (AltaVeg™M FA 140).

### Example 5

### TOFA/Vegetable-Based Composition Process Description

The procedure is conducted according to the procedure of Example 1, except instead of TOFA, the surface coating is prepared with 20% of a vegetable-oil-derived acid mixture (AltaVeg™ FA 140) and 20% of a TOFA (Altapyne® 1483).

### Example 6

### Comparison of Examplary Sample and Control in Hegman Draw Down

An exemplary oil composition and a control composition were tested by Hegman draw down.

### Samples

The control composition consisted of 22 m²/g ultrafine precipitated calcium carbonate (PCC) (ca. 70 nm nanoparticles, Calofort SV) that was coated with a 100% stearic/palmitic acid blend by the procedure of Example 1.

The exemplary composition MD1619 consisted of 22 m²/g ultrafine precipitated calcium carbonate (PCC) (ca. 70 nm nanoparticles, Calofort SV) that was coated with a 60% stearic/palmitic acid blend and 40% TOFA by the procedure of Example 1.

### Hegman Draw Down Test

For the test compositions, the PCC (31.0 g) was combined with diisononyl phthalate (DINP) (46.0 g) and 3 A molecular sieves (3.0 g) as a moisture scavenger to produce a 40% paste.

The procedure included a mixing time of 5×16 sec (@) 3000 rpm. The composition was mixed in a DAC 150.1 FVZ-K Speedmixer. Synergy Devises Limited. Prewetting was used before the first mixing, followed by scraping the sides and bottom between each mixing cycle.

The Hegman draw down was conducted according to the standard procedure of ASTM designation D 1210-96. The fineness of grind gauge was 5254.

### Results

In comparing the draw downs completed on a black substrate, the control sample shows poor dispersion. In comparing a mixing time of 5×16 sec@3000 rpm, the control sample showed a Hegman result of “3” (cleanliness rating A), while the MD1619 sample had a Hegman result of “7.0” (cleanliness rating A).

The comparison indicated that the MD1619 sample wetted out much quicker compared to the control. This indicates that it is more compatible with the DINP. Because the PCC powder wets out quicker, it has less time to ball up creating small agglomerates.

All publications and patent, applications cited in this specification are herein incorporated by reference as if each individual publication or patent application were specifically and individually indicated to be incorporated by reference. While the claimed subject matter has been described in terms of various embodiments, the skilled artisan will appreciate that various modifications, substitutions, omissions, and changes may be made without departing from the spirit thereof. Accordingly, it is intended that the scope of the subject matter limited solely by the scope of the following claims, including equivalents thereof.

1. A nanoparticulate composition, comprising surface-treated calcium carbonate nanoparticles;
wherein the calcium carbonate nanoparticles are treated with a fatty acid mixture comprising from about 40% to about 80% of a saturated fatty acid or mixture thereof and from about 20% to about 60% of an unsaturated fatty acid or mixture thereof;
wherein the unsaturated fatty acid or mixture thereof comprises at least about 10% elaidic acid or a salt thereof.

2. The nanoparticulate composition of claim 1, wherein the unsaturated fatty acid or mixture thereof comprises at least about 20% elaidic acid or a salt thereof.

3. The nanoparticulate composition of claim 1, wherein the unsaturated fatty acid or mixture thereof comprises a tall oil fatty acid (TOFA) or a salt thereof.

4. The nanoparticulate composition of claim 1, wherein the unsaturated fatty acid or mixture thereof comprises a vegetable-oil-based mixture or a salt thereof.

5. The nanoparticulate composition of claim 1, wherein the average particle diameter is from about 30 nm to about 200 nm.

6. The nanoparticulate composition of claim 1, wherein the average particle diameter is from about 50 nm to about 150 nm.

7. The nanoparticulate composition of claim 1, wherein the fatty acid mixture is from about 40% to about 64% of a saturated fatty acid or mixture thereof and from about 36% to about 60% of an unsaturated fatty acid or mixture thereof.

8. The nanoparticulate composition of claim 7, wherein the fatty acid mixture is about 60% of the saturated fatty acid or mixture thereof and about 40% of the unsaturated fatty acid or mixture thereof.

9. The nanoparticulate composition of claim 1, wherein the saturated fatty acid or mixture thereof comprises stearic acid or a salt thereof and palmitic acid or a salt thereof.

10. The nanoparticulate composition of claim 1, wherein the unsaturated fatty acid or mixture thereof comprises at least about 40% elaidic acid or the salt thereof.

11. The nanoparticulate composition of claim 1, wherein the unsaturated fatty acid or mixture thereof comprises oleic acid or a salt thereof and linoleic acid or a salt thereof.

12. A filler composition comprising the nanoparticle composition of claim 1.

13. A method of preparing the nanoparticle composition of claim 1, the method comprising:
preparing a surface coating emulsion comprising the fatty acid mixture under basic conditions; and
mixing the calcium carbonate nanoparticles with the surface coating emulsion.

14. The method of claim 13, wherein preparing the surface coating emulsion comprises
preparing a mixture with from about 5% to about 9% solids; and
stirring the mixture at about 80 to 85° C.

15. The method of claim 14, wherein stirring the mixture lasts for at least 30 min.

16. The method of claim 13, wherein the basic conditions require at least 1.03 equivalents of strong base.

17. The method of claim 13, wherein the method of preparing the nanoparticle composition further comprises
dewatering the surface-treated calcium carbonate nanoparticles.
